(19) United States
(12) Patent Application Publication
(10) Pub. No.: US 2006/0292442 A1
(43) Pub. Date: Dec. 28, 2006

(54) Electrochemical systems, terminal seals for use therewith and terminals for use therewith

(76) Inventors: Pinakin M. Shah, New Freedom, PA (US); Brian J. Stein, Owings Mills, MD (US); Nathan D. Isaacs, Baltimore, MD (US)

Correspondence Address: James G. Uber, Esq.;Mine Safety Appliances Company, P.O. Box 426, Pittsburgh, PA, 15230-0426, US

(21) Appl. No.: 11/334,310

(22) Filed: Jan. 18, 2006

Related U.S. Application Data
(60) Provisional application No. 60/694,403, filed on Jun. 27, 2005.

(51) Int. Cl. H01M 2/30; H01M 2/08

(52) U.S. Cl. 429/181; 429/184

(57) ABSTRACT

An insulated terminal for use in an electrochemical cell includes a terminal post and a polymeric insulating material forming a compression seal around the terminal post that maintains an hermetic seal over a temperature range of about −40° C. to +75°. A terminal for use in an electrochemical cell including a housing and an electrolyte within the housing includes a terminal post having an electrolyte contacting section including a first metal. The first metal is adapted to contact the electrolyte of the electrochemical cell. The terminal post further includes a contact section in electrically conductive connection with the electrolyte contacting section and being adapted to extend outside of the housing of the electrochemical cell. The contact section includes a sealing section including a second metal that is harder than the first metal. The sealing section also includes an insulating material which is held in sealing contact with the second metal of the sealing section via compression.

### CROSS-REFERENCE TO RELATED APPLICATION

The application claims the benefit of U.S. Provisional Patent Application Ser. No. 60/694,403, filed Jun. 27, 2005, the disclosure of which is incorporated herein by reference.

### BACKGROUND OF THE INVENTION

The present invention relates generally to electrochemical systems, to terminal seals for use therewith and to terminals for use therewith, and particularly, to electrochemical cells such as lithium ion cells, to compression seals for use as insulated terminals for such electrochemical cells and to terminals for use with such electrochemical cells.

A number of electrochemical systems such as lithium ion electrochemical cells include insulated terminals via which current is passed from the cells. Electrochemical batteries, which can include a number of electrochemical cells, can also include insulated terminals via which current is passed therefrom. FIGS. 1A and 1B illustrate, for example, an embodiment of a lithium ion electrochemical cell 10 available from Mine Safety Appliances Company of Sparks, Md. Electrochemical cell 10 includes a housing 20. Positive insulated terminal 30a and negative insulated terminal 30b are in operative connection with housing 20. FIG. 1B illustrates an exploded, disconnected view of the components of, for example, insulated terminal 30a. In general, positive insulated terminal 30a and negative insulated terminal 30b are identical in construction other than the material of metallic terminal posts 32a and 32b. In this embodiment, positive terminal post 32a is fabricated from a high purity aluminum alloy and negative terminal post 32b is fabricated from a high purity copper alloy. Each of positive terminal post 32a and negative terminal post 32b is insulated from and placed in sealed connection with housing 20 by an insulating sleeve 34a and 34b, respectively. Insulating sleeves 34a and 34b are maintained in sealed engagement with terminal posts 32a and 32b, respectively, via a stainless steel seal body 36a and 36b, respectively. In that regard, seal bodies 36a and 36b are crimped (see FIG. 1A) around insulating sleeves 34a and 34b, respectively, to maintain insulating sleeves 34a and 34b in compressed sealing engagement with terminal posts 32a and 32b, respectively. In general, insulating sleeve 34a is identical to insulating sleeve 32b, and seal body 36a is identical to seal body 36b.

As described above, the most desirable materials for terminal posts in seals for lithium-ion cells are high-purity aluminum alloys for the positive polarity terminal post and high-purity copper alloys for the negative polarity terminal post. While traditional glass-to-metal and ceramic-to-metal seals are capable of operating over a wide temperature range, they necessitate that joints of dissimilar metals (that is, metals other than copper at the negative terminal or aluminum at the positive terminal in the case of a lithium-ion cell) be exposed to the corrosive environment inside the cell. Undesirable reactions at dissimilar metal joints and on glass over time may degrade the performance of cells and cause leakage. Additionally, it is currently difficult, if not impossible to design and cost-effectively manufacture glass-to-metal or ceramic-to-metal seals with the aluminum and copper terminal posts of lithium-ion cells. Therefore, compression seals using thermoplastic insulators with the aluminum and copper terminal posts are generally used in the seal application as described above in connection with FIGS. 1A and 1B. However, the softness of high-purity aluminum poses a challenge in a large compression seal. In that regard, the relatively soft aluminum terminal post deforms before adequate compressive force can be established. This deformation combined with the limitations of TEFZEL® insulating sleeves (a copolymer of tetrafluoroethylene and ethylene available from DuPont Films) currently used in lithium ion electrochemical cells make it impossible to produce a seal that remains hermetic over a wide temperature range.

TEFZEL®, which has traditionally been used as a plastic insulator material in compression seals of insulated terminals, does not maintain adequate sealing compression over a wide temperature range. Moreover, TEFZEL® material moves excessively during the seal crimping operation. Likewise, TEFZEL® material has a tendency to creep over time, especially at higher temperatures, which then exacerbates leakage when such seals are exposed to low temperatures. Compression seals using a TEFZEL® insulating material typically remain hermetic between approximately +5° C. and +50° C. Outside of that temperature range, the seals have a tendency to leak, and loss of, for example, organic electrolyte from cells may cause safety and performance problems. Furthermore, cells utilizing such seals do not pass the Thermal Test required to meet new UN international regulations for the transport of lithium ion battery packs. See, UN Recommendations on the Transport of Dangerous Goods, Manual of Tests and Criteria, Fourth Revised Edition (2003), ST/SG/AC.10/11/Rev.4, Part 3, sub-section 38.3, the disclosure of which is incorporated herein by reference.

It is desirable, therefore, to develop improved electrochemical cells, insulated terminals and terminal posts that reduce or eliminate the above-identified problems and other problems associated with currently available electrochemical cells, insulated terminals and terminal posts.

### SUMMARY OF THE INVENTION

In one aspect, the present invention provides an insulated terminal for use in an electrochemical cell, including a terminal post and an insulating material forming a seal around the terminal post. The insulating material is preferably formed from a polymeric material having a coefficient of thermal expansion of preferably no greater than approximately 5.0×10⁻⁵ in./in./° F., a dielectric strength of preferably at least 100 V/mil, a lower temperature limit preferably no greater than −50° C., a heat deflection temperature at 264 lbs of preferably no less than approximately 100° C., a water absorption as measured over 24 hours at 73° F. of preferably not more than approximately 0.1%. The polymeric material is also preferably chemically resistant to an electrolyte or an electrolyte system used in the electrochemical cell and has an absorption of the electrolyte measured over 6 weeks at 71° C. of preferably not more than approximately 0.5%. The polymer also has a compressive strength of preferably no less than approximately 15,000 psi with 10% strain at 73° F. The insulating material can be sealed to the terminal post by a compression seal.

In several embodiments of the present invention, the polymeric material is polyphenylene sulfide (PPS), polyetheretherketone (PEEK), polyetherketone (PEK), polyamide-imide (PAI) or polyetherimide (PEI). The terminal post can, for example, include copper. Likewise, the terminal post can include aluminum. In one embodiment, the terminal post includes aluminum in that area of the terminal post that contacts the electrolyte of the electrochemical cell and includes another metal that is harder than aluminum within a sealing section, portion or area of the terminal post contacted by the insulating material. The another metal can, for example, be copper.

In another aspect, the present invention provides a terminal for use in an electrochemical cell including a housing and an electrolyte within the housing. The terminal includes a terminal post having an electrolyte contacting section including a first metal. The first metal is adapted to contact the electrolyte of the electrochemical cell. The first metal can, for example, be aluminum (for use, for example, in a lithium-ion cell). The terminal post further includes a contact section in electrically conductive connection with the electrolyte contacting section and being adapted to extend outside of the housing of the electrochemical cell. The contact section includes a sealing section including a second metal that is harder than the first metal. The sealing section is adapted to form a seal with an insulating seal which is held in sealing contact with an exterior surface of the sealing section via compression.

In one embodiment, the electrolyte contacting section of the terminal post includes a first section adapted to extend into an interior of the housing of the electrochemical cell wherein it comes into contact with the electrolyte and a second section adapted to extend outside of the of the housing of the electrochemical cell to transmit current. In this embodiment, the contact section includes a supporting section fabricated from the second metal in adjacent contact with the first metal of the second section over at least a portion of the sealing section.

In one embodiment, the second section of the electrolyte contacting section is formed to have a seating therein. In this embodiment, the supporting section is formed as a core that is adapted to be seated within the seating of the second section. The core is fabricated from the second metal, which can, for example, be copper. Preferably, the first section and the second section of the electrolyte contacting section of the terminal post are formed integrally or monolithically of the first metal. Preferably, the contact section includes an electrical contact that is formed integrally or monolithically of the second metal with the core.

The terminal can further include an insulating material adapted to be held in sealing compressive contact with the terminal post in the area of the sealing section. In general, the second, harder metal enables a better compressive seal between the insulating material and the terminal.

The terminal can further include a connecting mechanism for attaching the core within the seating of the second section. In one embodiment, the connecting mechanism includes a threaded section formed on an interior surface of the seating and a cooperating threaded section formed on an exterior surface of the core. The threaded section can be coated with a first highly conductive material, and the cooperating threaded section can be coated with a second highly conductive material. The first highly conductive material and the second highly conductive material can, for example, be nickel.

The terminal can further include a seal housing that is crimped around the insulating material. In one embodiment, the insulating material is preferably formed from a polymeric material having a coefficient of thermal expansion of preferably no greater than approximately 5.0×10⁻⁵ in./in./° F., a dielectric strength of preferably at least 100 V/mil, a lower temperature limit preferably no greater than −50° C., a heat deflection temperature at 264 lbs of preferably no less than approximately 100° C., a water absorption as measured over 24 hours at 73° F. of preferably not more than approximately 0.1%, and an absorption of electrolyte used in the electrochemical cell as measured over 6 weeks at 71° C. of preferably not more than approximately 0.5%. The polymeric material also has a compressive strength of preferably no less than approximately 15,000 psi with 10% strain at 73° F. The polymeric material is also preferably chemically resistant to the electrolyte or the electrolyte system. The polymeric material can, for example, be polyphenylene sulfide, polyetheretherketone, polyetherketone, polyamide-imide or polyetherimide.

In another aspect, the present invention provides an electrochemical cell including: an electrolyte and at least a first insulated terminal in contact with the electrolyte. The insulated terminal includes a terminal post and an insulating material forming a seal around the terminal post. The insulating material is preferably formed from a polymeric material having a coefficient of thermal expansion of preferably no greater than approximately 5.0×10⁻⁵ in./in./° F., a dielectric strength of preferably at least 100 V/mil, a lower temperature limit preferably no greater than −50° C., the heat deflection temperature at 264 lbs of preferably no less than approximately 100° C., a water absorption as measured over 24 hours at 73° F. of preferably not more than approximately 0.1%, and an absorption of electrolyte used in the electrochemical cell as measured over 6 weeks at 71° C. of preferably not more than approximately 0.5%. The polymeric material also has a compressive strength of preferably no less than approximately 15,000 psi with 10% strain at 73° F. The polymeric material also preferably chemically resistant to the electrolyte or the electrolyte system. The electrochemical cell can, for example, be a lithium ion cell.

The electrochemical cell can further include a second terminal in contact with the electrolyte, which includes a terminal post. The terminal post can, for example, include a terminal post having an electrolyte contacting section including a first metal as described above.

In still a further aspect, the present invention provides a lithium ion electrochemical cell having a housing, an electrolyte within the housing and an insulated positive terminal including a terminal post. The terminal post includes an electrolyte contacting section extending within the housing to contact the electrolyte. The electrolyte contacting section includes aluminum. The terminal post further includes a contact section extending outside the housing. The contact section is in electrically conductive connection with the electrolyte contacting section. The contact section includes a sealing section, which includes a second metal over at least a portion thereof. The second metal is harder than aluminum. The positive terminal further includes an insulating sleeve including polyphenylene sulfide and a seal body including stainless steel. The seal body is crimped around the insulating sleeve to maintain the insulating sleeve in compressed sealing engagement with the sealing section. The second metal can, for example, be copper. The electrochemical cell can further include an insulated negative terminal including a terminal post fabricated integrally or monolithically from copper, an insulating sleeve including polyphenylene sulfide and a seal body including stainless steel.

### BRIEF DESCRIPTION OF THE DRAWINGS

Other aspects of the invention and advantages thereof will be discerned from the following detailed description when read in connection with the accompanying drawings, in which:

FIG. 1A illustrates a side view of one embodiment of a currently available lithium ion electrochemical cell.

FIG. 1B illustrates a side, partially cross-sectional, exploded view of an insulated, positive polarity terminal used in the electrochemical cell of FIG. 1A.

FIG. 2A illustrates a side view of one embodiment of a representative lithium ion electrochemical cell of the present invention.

FIG. 2B illustrates a top plan view of the electrochemical cell of FIG. 2A.

FIG. 3A illustrates a cross-sectional view of an insulating sleeve used in the electrochemical cell of FIG. 2A.

FIG. 3B illustrates a top plan view of the insulating sleeve of FIG. 3A.

FIG. 4A illustrates a side, cross-sectional view of one embodiment of a stainless steel seal body used in the electrochemical cell of FIG. 2A.

FIG. 4B illustrates a top plan view of the seal body of FIG. 4A.

FIG. 4C illustrates an enlarged cross-sectional view of the encircled portion of the body of FIG. 4B.

FIG. 5A illustrates a side view of one embodiment of a negative polarity terminal post used in the electrochemical cell of FIG. 2A.

FIG. 5B illustrates another side view of the negative polarity terminal post of FIG. 5A in which the terminal post has been rotated about its axis by 90° compared to the orientation of FIG. 5A.

FIG. 5C illustrates an enlarged side view of the encircled portion of the terminal post of FIG. 5A.

FIG. 5D illustrates a top plan view of the terminal post of FIG. 5A.

FIG. 5E illustrates a side view of the assembled negative polarity terminal incorporating the terminal post of FIG. 5A, the seal body of FIG. 4A and the insulating sleeve of FIG. 3A.

FIG. 5F illustrates a top plan view of the negative polarity insulated terminal of FIG. 5E

FIG. 5G illustrates a side, cutaway view of the negative polarity insulated terminal of FIG. 5F.

FIG. 6A illustrates a side, hidden line view of one embodiment of an upper or contact section for a positive polarity terminal post used in the electrochemical cell of FIG. 2A

FIG. 6B illustrates a top plan view of the upper or contact section of the positive polarity terminal post of FIG. 6A.

FIG. 6C illustrates another hidden line view of one embodiment of an upper section of FIG. 6A wherein the upper section has been rotated about its axis by 90° compared to the orientation of FIG. 6A.

FIG. 6D illustrates an enlarged side view of the encircled portion of the upper or contact section of FIG. 6C.

FIG. 6E illustrates a side, cross-sectional view of an embodiment of a lower or electrolyte contacting section of a positive polarity terminal post used in connection with the upper section of FIG. 6A.

FIG. 6F illustrates a top plan view of the lower or electrolyte contacting section of FIG. 6E.

FIG. 6G illustrates an enlarged side view of the encircled portion of the lower or electrolyte contacting section of FIG. 6E, which contacts the electrolyte within the housing of the electrochemical cell of FIG. 2A.

FIG. 6H illustrates a side, cutaway view of an assembled positive polarity terminal post of the present invention incorporating the upper or contact section of FIG. 6A and the lower or electrolyte contacting section of FIG. 6E, which is aligned for insertion into an assembly including the seal body of FIG. 4A and the insulating sleeve of FIG. 3A.

FIG. 6I illustrates a side view of the assembled positive polarity insulated terminal.

FIG. 6J illustrates a top plan view of the positive polarity insulated terminal of FIG. 6I.

FIG. 6K illustrates a side, cut away view of the of the positive polarity insulated terminal of FIG. 6I.

FIG. 7A illustrates a side, cutaway view of another embodiment of a disassembled terminal of the present invention including a terminal post which is aligned for insertion into an assembly including the seal body of FIG. 4A and the insulating sleeve of FIG. 3A, the terminal post having an electrolyte contacting section, an electrical contact section and a support section or sleeve.

FIG. 7B illustrates a side, cutaway view of the terminal post of FIG. 7A wherein the support sleeve is assembled upon the electrical contact section to form a sealing section.

FIG. 7C illustrates a side, cut away view of the insulated terminal of FIG. 7A in a fully assembled state.

FIG. 8A illustrates a side, cutaway view of another embodiment of a disassembled terminal of the present invention including a terminal post which is aligned for insertion into an assembly including the seal body of FIG. 4A and the insulating sleeve of FIG. 3A, the terminal post having an electrical contact section and an electrolyte contacting section.

FIG. 8B illustrates a side, cutaway view of the terminal post of FIG. 8A wherein the electrical contact section and the electrolyte contacting section are connected and form an intermediate sealing section.

FIG. 8C illustrates a side, cut away view of the insulated terminal of FIG. 8A in an assembled state.

FIG. 9A illustrates a side, cutaway view of another embodiment of a disassembled terminal of the present invention including a terminal post which is aligned for insertion into an assembly including the seal body of FIG. 4A and the insulating sleeve of FIG. 3A, the terminal post having an electrical contact section and an electrolyte contacting section.

FIG. 9B illustrates a side, cutaway view of the terminal post of FIG. 8A wherein the electrical contact section and the electrolyte contacting section are connected.

FIG. 9C illustrates a side, cut away view of the insulated terminal of FIG. 9A in an assembled state.

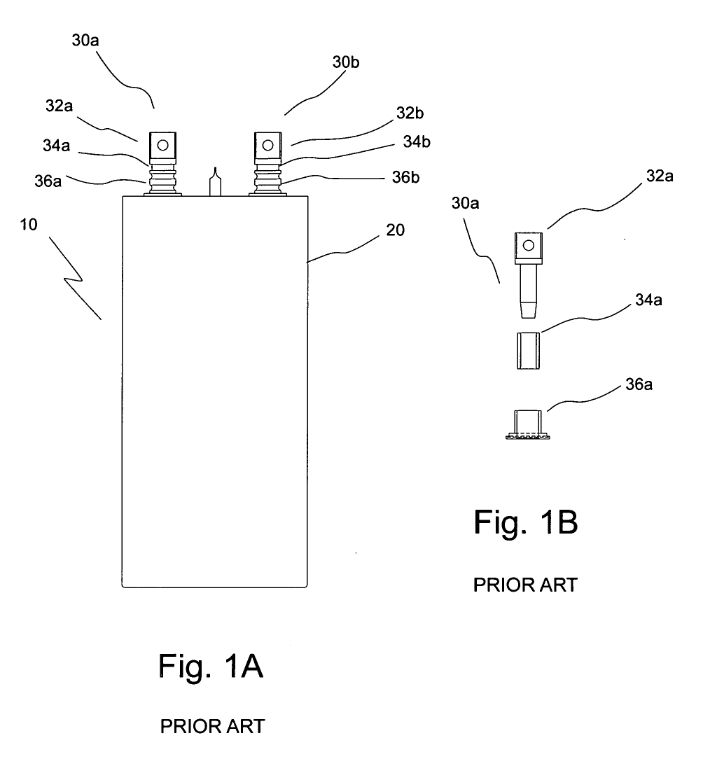

### DETAILED DESCRIPTION OF THE INVENTION

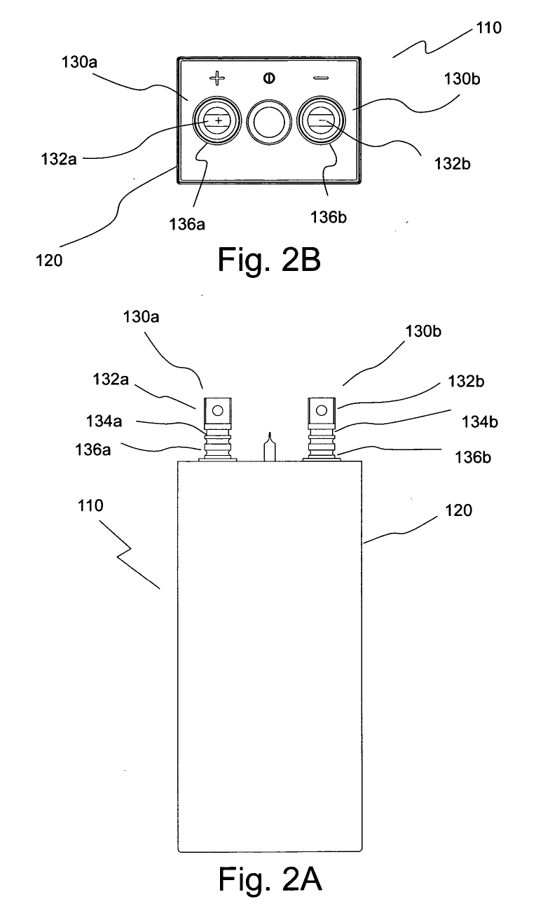

FIGS. 2A and 2B illustrate a representative embodiment of an electrochemical system of the present invention in the form of a lithium ion electrochemical cell 110 used in several studies of the present invention. Electrochemical cell 110 is, in outward appearance, similar to electrochemical cell 10. In that regard, electrochemical cell 110 includes a housing 120. Positive insulated terminal 130a and negative insulated terminal 130b are in operative connection with housing 120. Positive insulated terminal 130a and negative insulated terminal 130b include metallic terminal posts 132a and 132b. Each of positive terminal post 132a and negative terminal post 132b is insulated from and placed in sealed connection with housing 120 using an insulating sleeve 134a and 134b, respectively. Insulating sleeves 134a and 134b are maintained in sealed engagement with terminal posts 132a and 132b, respectively, via a stainless steel seal body 136a and 136b, respectively. Seal bodies 136a and 316b are crimped around insulating sleeves 134a and 134b, respectively, to maintain insulating sleeves 134a and 134b in compressed sealing engagement with terminal posts 132a and 132b, respectively.

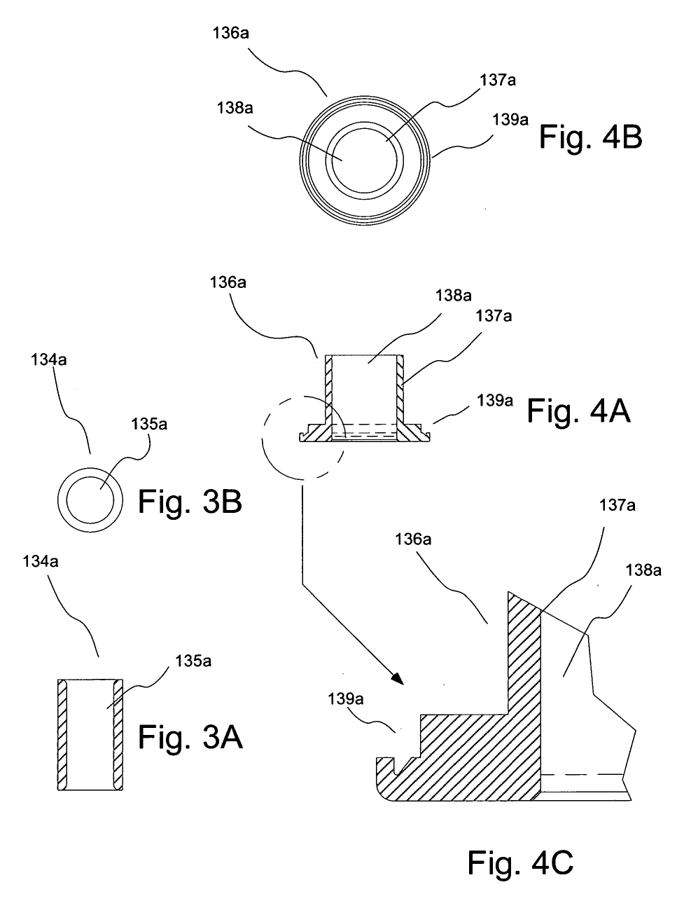

FIGS. 3A and 3B illustrate insulating sleeve 134a, and FIGS. 4A-4C illustrate seal body 136a, wherein insulating sleeve 134a and seal body 136a are disconnected from the remaining components of insulated terminal 130a. In general, insulating sleeves 134a and 134b are identical, and seal bodies 136a and 136b are identical. Like components of insulating sleeve 134a and 134b and like components of seal bodies 136a and 136b are numbered in a corresponding manner. Insulating sleeve 134a in the illustrated embodiment is generally cylindrical in shape and includes a generally cylindrical passage 135a through which a section of terminal post 132a is passed as further described below. Seal body 136a includes a generally cylindrical crimping section 137a having a passage 138a therethrough which surrounds insulating sleeve 134a as further described below. Seal body 136a further includes a base section 139a at a bottom thereof (in the orientation of, for example, FIGS. 4A-4C) which forms an operative connection with housing 120.

In one embodiment, the present invention provides an improved compression seal for use with insulated terminals 130a and 130b and other insulated terminals for use in electrochemical systems. The compression seals of the present invention enable the manufacture of lithium-ion rechargeable cells and batteries (and other electrochemical systems) that remain hermetically sealed when operated over a wide temperature range. Indeed, the compression seals of the present invention have been successfully tested on lithium-ion cells 110 as illustrated in FIGS. 2A and 2B in a temperature range of approximately −40° C. to +75° C. without loss of mass or hermeticity. The compression seals of the present invention also remain hermetic during abusive tests that include altitude, shock, vibration and electrical short-circuiting.

In a first aspect of the present invention, the inventors have discovered that thermoplastic polymeric materials having certain physiochemical characteristics provide a material for insulating sleeves 134a and 134b which, when crimped on terminal posts 132a and 132b, produce a liquid and gas-tight seal over the above-identified temperature range. In a second aspect of the present invention, an improved positive polarity terminal post 132a is provided which includes a core of relatively hard material that facilitates seal hermeticity over a wide temperature range. In a preferred embodiment of a lithium-ion electrochemical cell of the present invention, positive terminal post 132a was fabricated as a composite terminal including a high purity aluminum alloy and a high purity copper alloy, and negative terminal post 132b was preferably fabricated from a high purity copper alloy.

In general, the polymeric material for insulating sleeves 134a and 134b of the present invention preferably has a dielectric strength of at least approximately 100 V/mil. The polymeric insulating material also preferably exhibits the mechanical properties set forth below. Preferably, the coefficient of thermal expansion is no greater than approximately 5.0×10⁻⁵ in./in./° F. and more preferably no greater than approximately 3.0×10⁻⁵ in./in./° F. The material preferably exhibits a tensile strength of preferably at least 10,000 psi, a tensile modulus of preferably at least 400,000 psi, a tensile elongation at break of preferably no more that 100%, a flexural strength of preferably at least 15,000 psi, a flexural modulus of preferably at least 500,000 psi, a compressive strength (10% strain at 73° F.) of preferably at least 15,000 psi and a compressive modulus of preferably at least 400,000 psi.

Also, the material should exhibit limited creep over time. Polymeric materials such as thermoplastics are viscoelastic. In that regard, polymeric materials exhibit both elastic and viscous behavior. Thus, polymeric materials deform under a load with both an immediate response (an elastic response) and a slower response (a viscous response). A plastic material can slowly change shape to relieve an applied load. Such materials exhibit a time-dependent increase in deformation or strain, called creep, over time under a constant load. Creep is thus a slow and progressive deformation of the material with time under a constant stress. The amount of creep is very temperature sensitive. In general, there is no established method of determining creep. ASTM D674 describes a flexural creep method frequently used, although it is not a test method but a “recommended practice for creep tests.” It discusses the complications of measuring creep, and the precautions to be taken when using creep data. Complications arise, in large part, because creep measurements are made over a long period of time, for example, several months to a year or more. Complications also arise from the dependency of creep upon temperature and load conditions.

Preferably, creep of the insulating materials used in the present invention is limited such that once a compressive force is applied to the polymeric insulating material of the present invention via crimping of the seal body such that the insulating material is compressed between the seal body and the terminal post, and the material responds by physically displacing based upon its compressive strength, the resulting dimensions of the insulating material under a static load remain as close to constant over time as possible. In this application where a wide operational temperature range is required, the compressive strength (as described above) of the material and the material's upper temperature limit (as described below) provide good relative indicators of the polymeric insulating material's resistance to creep. In that regard, a suitable polymeric insulating material exhibits both a high compressive strength and a high upper temperature limit, and therefore a high resistance to creep. Materials with lower compressive strengths, such as the TEFZEL® material, and materials with lower upper temperature limits, such as polyethylene or polypropylene, are generally less resistant to creep in such an application. The tendency to creep of such materials can compromise the integrity of the insulated terminals of the present invention, and the hermeticity of the required seal.

Likewise, the polymeric material should be chemically resistant to the electrolyte system used within electrochemical cell 110 or other electrochemical system (including, for example, an electrolyte, any solvent and any reaction products or contaminants that may be present in the electrolyte system over the life of the electrochemical system). Hydrofluoric acid (HF), for example, is a product of reaction of an electrolyte salt (LiPF₆) and water contamination in the electrolyte used in several studies of the present invention. Although this is an undesirable reaction, it cannot be avoided as ppm levels of water are always present in salt and organic solvents used in the electrolyte. As HF is highly reactive, the polymeric material must be chemically resistant to the HF to prevent compromise of the seal integrity over long-term use such that the seal remains hermetic. The material should further be resistant to transmission of water vapor and electrolyte therethrough. In that regard, the material preferably exhibits a water absorption (24 hrs. at 73° F.) of not more than approximately 0.1% and an organic electrolyte absorption (6 weeks at 71° C.) of not more than approximately 0.5%.

The insulating material also preferably exhibits the thermal properties set forth below. Preferably, the material exhibits a lower temperature limit of no higher than approximately −50° C., an upper temperature limit of no less than approximately 100° C., a glass transition temperature of no less than approximately 80° C. and a heat deflection temperature (at 264 lbs) of no less than approximately 100° C. The lower temperature limit is the lowest temperature at which a material can be expected to retain its physical, mechanical and chemical properties as specified by the manufacturer. The upper temperature limit is the highest temperature at which a material can be expected to retain its physical, mechanical and chemical properties as specified by the manufacturer. The heat-deflection temperature is the temperature at which a test bar of material deflects a specified amount under a stated load (264 pounds in the studies of the present invention) as set forth in ASTM D 648, the disclosure of which is incorporated herein by reference. This temperature is also referred to as the deflection temperature under load (DTUL) and the heat distortion temperature.

Of the above properties, the compressive strength, the coefficient of thermal expansion, the dielectric strength, the upper temperature limit, the lower temperature limit, the heat deflection temperature, the water absorption, the electrolyte absorption, and the chemical resistance to the electrolyte were considered the most important in choosing insulating materials for several studies of the present invention.

Polyphenylene sulfide (PPS, a thermoplastic polycondensate available, for example, from Chevron Phillips Chemical Company LLC of The Woodlands, Texas under the trademark RYTON®) is a polymeric insulating material found to provide the preferred physiochemical properties set forth above and produces a seal that meets the demanding requirements of the new UN shipping requirements. PPS is also commercially known as TECHTRON®. Several of the mechanical, thermal, electrical and chemical properties of PPS are set forth in Table 1. Preferably, PPS used in the present invention is “virgin” or unfilled PPS. PPS is chemically compatible with the lithium-ion electrochemical system and was found to overcome the shortcomings of the TEFZEL® material set forth above.

TABLE 1

| | Polyphenylene |
|---|---|
| Properties | Sulfide (PPS) |
| MECHANICAL PROPERTIES | |
| Coefficient of Thermal Expansion (in./in./° F.) | 2.8 × 10⁻⁵ |
| Tensile Strength (psi) | 13,500 |
| Tensile Modulus (psi) | 500,000 |
| Tensile Elongation at Break (%) | 15 |
| Flexural Strength (psi) | 21,000 |
| Flexural Modulus (psi) | 575,000 |
| Compressive Strength, 10% strain @ 73° F. (psi) | 21,500 |
| Compressive Modulus (psi) | 430,000 |
| ELECTRICAL PROPERTIES | |
| Dielectric Strength (V/mil) | 540 |
| THERMAL PROPERTIES | |
| Lower Temperature Limit (° C.) | −267 |
| Upper Temperature Limit (° C.) | 218 |
| Glass Transition Temperature (° C.) | 85 |
| Heat Deflection Temperature @ 264 lbs. (° C.) | 135 |
| CHEMICAL PROPERTIES | |
| Water Absorption, 24 hrs. @ 73° F. (%) | 0.01 |
| Organic Electrolyte Absorption, 6 weeks @ 71° C. (%) | 0.46 |
| Resistance to Hydrofluoric Acid | excellent |
| Cobalt-60 Gamma Radiation Degradation** (%) | none |

**as measured by DSC

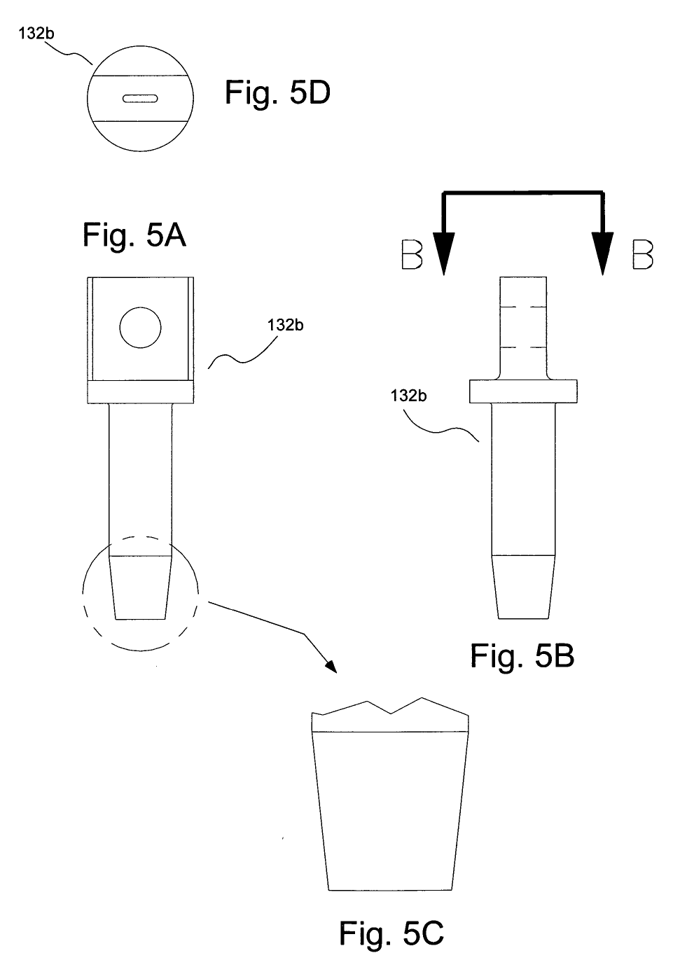

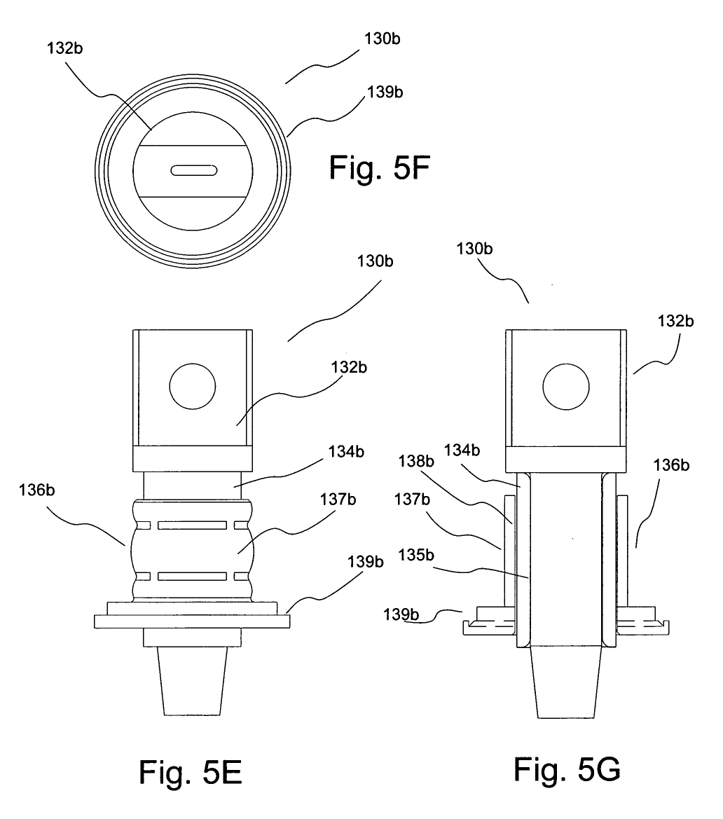

FIGS. 2A, 2B and 5A-5G illustrate an embodiment of insulated, negative polarity terminal 130b and components thereof used in studies of the present invention. In the illustrated embodiment, terminal post 132b was formed of a high-purity copper alloy and insulating sleeve 134b was formed from virgin PPS.

In assembling insulated negative terminal 130b, insulating sleeve 134b was first inserted into passage 138b of a stainless steel seal body 136b. Terminal post 132b (see, for example, FIG. 5G) was then inserted inside passage 135b of insulating sleeve 134b and the entire assembly was crimped in a machine (as known in the crimping arts). The external part of the negative terminal post was gold-plated for good electrical contact and long-term corrosion resistance. PPS insulating sleeve 134b was found to provide a seal in connection with negative terminal 130b of electrochemical cell 110 that met the demanding requirements of the new UN shipping requirements.

However, use of a polymeric insulating sleeve, such as a PPS sleeve having the above physiochemical characteristics, alone did not prevent seal failures under the new UN shipping requirements in the case of an insulated, positive polarity terminal formed from aluminum. As described above, the most desirable material for a terminal post in a positive polarity terminal for a lithium-ion electrochemical cell is a high-purity aluminum alloy. Once again, however, the softness of high-purity aluminum poses a significant challenge in forming a compression seal. The relative softness of an aluminum terminal post resulted in seal failures even with the use of a polymeric insulating material, such as PPS, having the physiochemical properties set forth above.

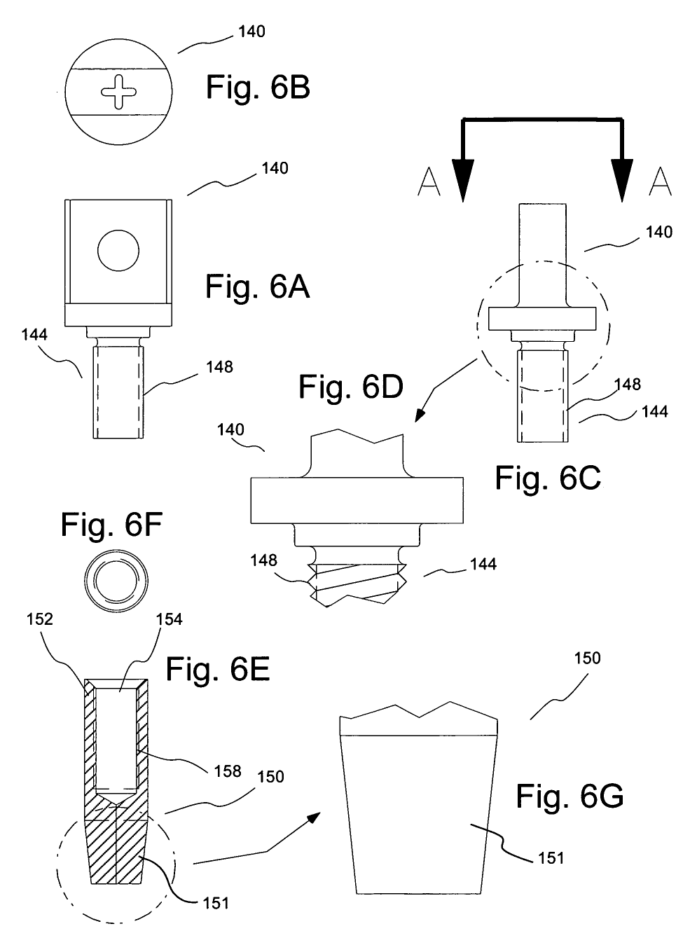

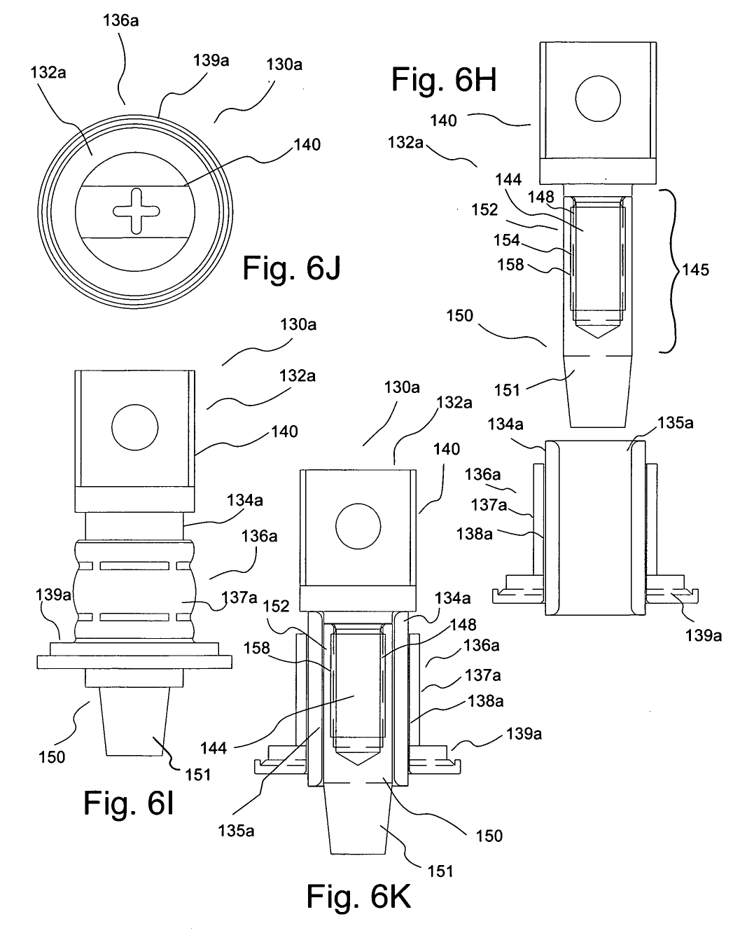

FIGS. 2A, 2B and 6A-6K, illustrate an embodiment of insulated, positive polarity terminal 130a and components thereof used in several studies of the present invention to overcome the deformation problems posed by high-purity aluminum alloys. In that regard, to fully realize the advantages of insulating materials having the above-identified physiochemical properties over currently used insulating materials (for example, TEFZEL® material), a novel, composite positive terminal post 132a was developed. Positive terminal post 132a included an upper section or electrical contact section 140 that was formed (at least in part, but preferably integrally or monolithically) from a material that was harder (that is, less easily deformable) than aluminum. In general, upper section or electrical contact section 140 extends out of housing 120 to from an electrical connection with a conductive element connected thereto. In several studies of the present invention, upper section 140 was formed monolithically from copper. Upper section 140 included a core section 144 that was connected to a lower section 150 (preferably fabricated integrally or monolithically from aluminum). Lower section 150 included an electrolyte contacting section 151 on a lower end thereof which contacts the electrolyte within housing 120 of electrochemical cell 110. In the illustrated embodiment, lower section 150 further included a generally cylindrical shell or sleeve section 152 including a seating or passage 154 formed therein. In assembled electrochemical cell 110, sleeve section 152 extends outside of housing 120. Core section 144 of upper section 140 was inserted into passage 154 and together formed a sealing section 145 of terminal post 132a. A connecting mechanism was used to form a connection between core section 144 and shell section 152. As illustrated in FIGS. 6A-6K, core section 144 can include male threading 148 formed on the exterior surface thereof that cooperates by forming a mating connection with female threading 158 formed on an interior surface of passage 154 to form a connection between core section 144 of upper section 140 and shell section 152 of lower section 150.

Similar to insulated negative terminal 130b, in assembling insulated positive terminal 130a, insulating sleeve 134a was first inserted into passage 138a of stainless steel seal body 136a. Assembled composite terminal post 132a (see, for example, FIG. 6H) was then inserted inside passage 135a of insulating sleeve 134a and the entire assembly was crimped in a machine (as known in the crimping arts). Upper section 140 was nickel plated over all surfaces thereof. Threaded section 158 of lower section 150 was also nickel plated. The nickel plating provides for good electrical contact and long-term corrosion resistance.

Thermoplastics materials other than PPS and having at least some of the physiochemical properties set forth above can be used for insulating sleeves 134a and 134b of the present invention. Of the above properties set forth above in guiding selection of an insulating material, the insulating material preferably at least exhibits the compressive strength, the upper temperature limit, the coefficient of thermal expansion, the dielectric strength, the lower temperature limit, the heat deflection temperature, the water absorption, the electrolyte absorption, and the chemical resistance to the electrolyte system set forth above. Such materials can, for example, include, but are not limited to, polyetheretherketone (PEEK), polyetherketone (PEK), polyamide-imide (PAI) or polyetherimide (PEI). With respect to chemical resistance to the electrolyte systems of the present invention, HF concentration in a cell is generally very small (at the ppm level) and not all of the HF comes into contact with the insulating material. The polymeric material of insulating sleeves 134a and 134b need only be resistant to the concentrations of HF experienced in the cell. Moreover, other electrochemical systems may not require resistance to HF because such systems may utilize an electrolyte salt other than LiPF₆, (for example, lithium bis(oxalato)borate or LiBOB, LiB(C₂O₄)₂) to provide electrolyte conductivity. Electrolytes prepared with non-fluorine-containing salts do not produce HF in the presence of moisture.

Core section 144 or other supporting section of upper section 140 of positive terminal post 132a can be formed from materials other than copper, including, but not limited to hard metals such as nickel, steels, titanium, INCONEL® (a high strength, austenitic nickel-chromium-iron alloy), and MONEL® (an alloy of nickel and copper and other metals such as iron and/or manganese and/or aluminum). In general, such materials are sufficiently harder than aluminum to prevent significant deformation in sealing section or sealing portion 145 of assembled positive polarity terminal post 132a around which insulating sleeve 134a is compressed such that no substantial leakage occurs under the testing regime of the UN regulations. Such metals can be plated (for example, with nickel, silver, or gold) to provide good electrical contact and corrosion resistance.

Likewise, connections other than the threaded connection described herein can be formed between core section 144 and shell section 152 as known in the art. The hermetically sealed, insulated terminals of the present invention can be used in many electrochemical systems other than the representative lithium ion electrochemical cells discussed herein. Such electrochemical systems include, but are not limited to, Ni/H₂ cells, supercapacitors, and other battery systems requiring storage of aqueous or high vapor pressure organic liquids.

As known to those skilled in the art, parameters such as crimping force, crimp tooling and part geometry are interrelated and can each effect the efficacy of the crimping process. Crimping force is defined as the force, measured in pounds per square inch, applied by the crimping jaws upon the seal assembly components during the crimping process. Crimping force is preferably optimized to impart an adequate level of compressive force between the compressed seal assembly components to maintain long-term hermeticity within the required temperature range. An adequate amount of crimping force does not cause excessive deformation of the components in the seal, which could compromise hermeticity and violate the dimensional limits of the seal design. The crimping force is preferably applied at a uniform rate, and once attained is maintained for a predetermined period of time known as dwell. Tooling parameters include the details describing the crimp tooling used in the crimping machine to transfer the crimping force to the seal assembly during the crimping process. Tooling parameters include the materials of construction, and related mechanical and physical properties, such as strength, temper and surface finish. The geometry, number and pitch of crimp ridges on the tooling are preferably selected to accommodate variations in seal component sizes and materials. Part geometry refers to the size and surface finish of the mating seal components that control the fit of the parts required by the design. The fit is controlled to balance seal manufacturability with an adequate level of part interference needed to ensure effective crimping. Crimping force, tooling and part geometry are readily optimized by one skilled in the art based on the materials of construction and the overall size of the seal assembly. In several studies of the present invention two annular crimps were provided using a crimping machine with a 105 psi machine setting.

As described above, significant problems arose with previously available insulated terminals as a result of the degree of deformation caused to the solid aluminum terminal post and a TEFZEL® material seal insulator of such terminals during the crimping process. Such excessive deformation can compromise the integrity of the materials and their ability to deliver long-term, high-reliability performance. In the case of positive terminal 130a, terminal post 132a and insulating sleeve 134a resulted in significant reductions in component deformation as compared to previously available terminals using a solid aluminum terminal post and a TEFZEL® material seal insulator. Deformation of terminal post 132a was reduced by 80%, from an average increase in length of 0.040″ to 0.008″. Deformation of seal insulator 134a was reduced by 69%, from an average increase in length of 0.055″ to 0.017″. These reductions significantly increase retention of base material characteristics and enhance their ability to deliver long-term, high-reliability performance.

The insulated terminals of the present invention underwent a series of performance tests and were found to perform acceptably over a wide range of conditions. For example, the insulated terminals were found to pass the UN Thermal Cycling Test of Discrete Seals. After thermal cycling (11 cycles of −40° C. to +75° C.) with a 6-hour dwell time at each temperature for 10-Ah seals and cells, and a 12-hour dwell time for 50-Ah seals and cells, the helium leak rate was less than 1.0×10⁻⁸ std-cc/sec as measured on a Veeco helium mass spectrometer at the test temperature extremes. Likewise, the insulated terminals of the present invention were found to pass the UN Thermal Cycling Test for test cells by remaining hermetic between −40° C. to +75° C.

In other performance testing, the difference in electrical series resistance between an un-plated positive terminal post 132a of the present invention and a solid aluminum terminal post used in prior cells was found to be less than 5 micro-ohms. In a radiation exposure test, negative seal assemblies 130b were found to remain hermetic after exposure to 43 Mrad ⁶⁰Co gamma radiation. Positive terminal posts 132a in positive terminals 130a were found to be more resistant to various torque and normal forces than prior designs. In vibration testing, electrochemical cells of the present invention showed no voltage anomalies during discharge throughout the vibration test at 26.9 g rms. No signs of leakage were visible in short circuit testing at room temperature and at +55° C.

As described above, in several embodiments the present invention provides terminals for use in electrochemical cells that include a terminal post having an electrolyte contacting section including a first metal, wherein the first metal is adapted to contact the electrolyte of the electrochemical cell. In certain circumstances, the first metal may not be sufficiently hard to form a suitable and/or lasting compression seal with a sealing section. The terminal posts of the present invention thus further include a contact section in electrically conductive connection with the electrolyte contacting section. The contact section extends outside of the housing of the electrochemical cell. The contact section includes a sealing section including a second metal that is harder than the first metal. The sealing section is suitable to form a seal with an insulating seal which is held in sealing contact with an exterior surface of the sealing section via a compression seal. In addition to the terminal posts described above, there are various other manners in which the terminals of the present invention can be fabricated.

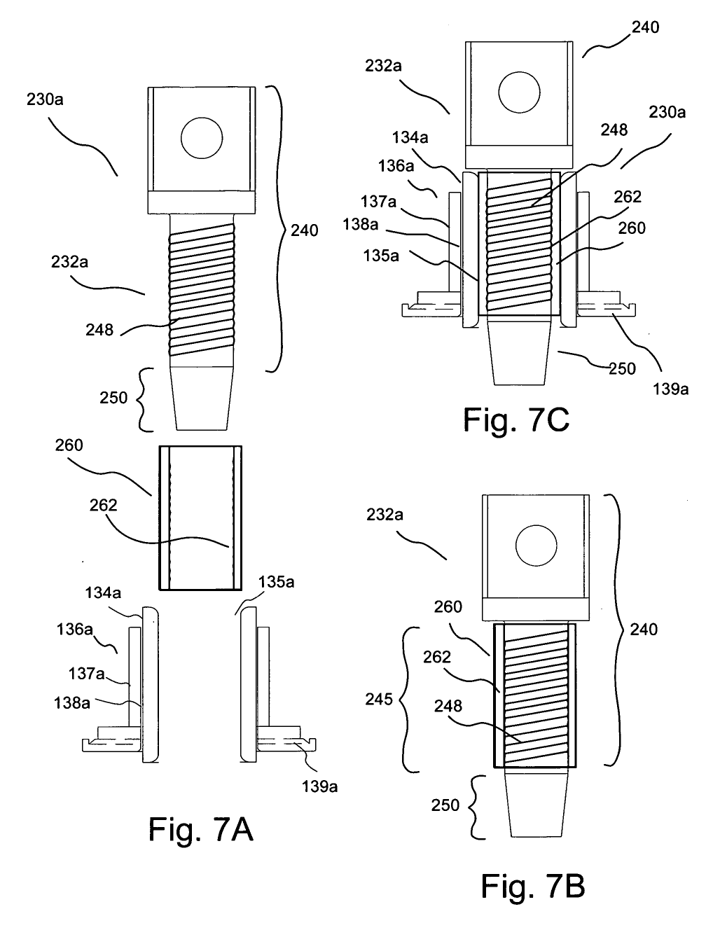

For example, FIGS. 7A through 7C illustrate an embodiment of a terminal 230a of the present invention including a terminal post 232a (for example, a positive terminal post for use in a lithium ion cell) having an electrical contact section 240 formed integrally or monolithically with an electrolyte contacting section 250. Electrical contact section 240 and the electrolyte contacting section 250 are formed monolithically from a first metal suitable for contacting the electrolyte (for example, aluminum in the case of a lithium ion cell). Electrical contact section 240 of terminal post 232a further includes a support section or sleeve 260 formed from a second metal that is harder than the first metal (for example, copper in the case of a lithium ion cell). Support sleeve 260 includes a connector such as threading 262 which cooperates with a connector such as cooperating threading 248 of electrical contact section 240 to connect support sleeve 260 thereto to form a sealing section 245 (see, for example, FIG. 7B).

As illustrated in FIG. 7C, in assembling insulated positive terminal 230a, assembled composite terminal post 232a is inserted inside passage 135a of insulating sleeve 134a and the entire assembly is subsequently crimped. Support sleeve 260 provides sufficient hardness over sealing section 245 to provide a suitable compression seal.

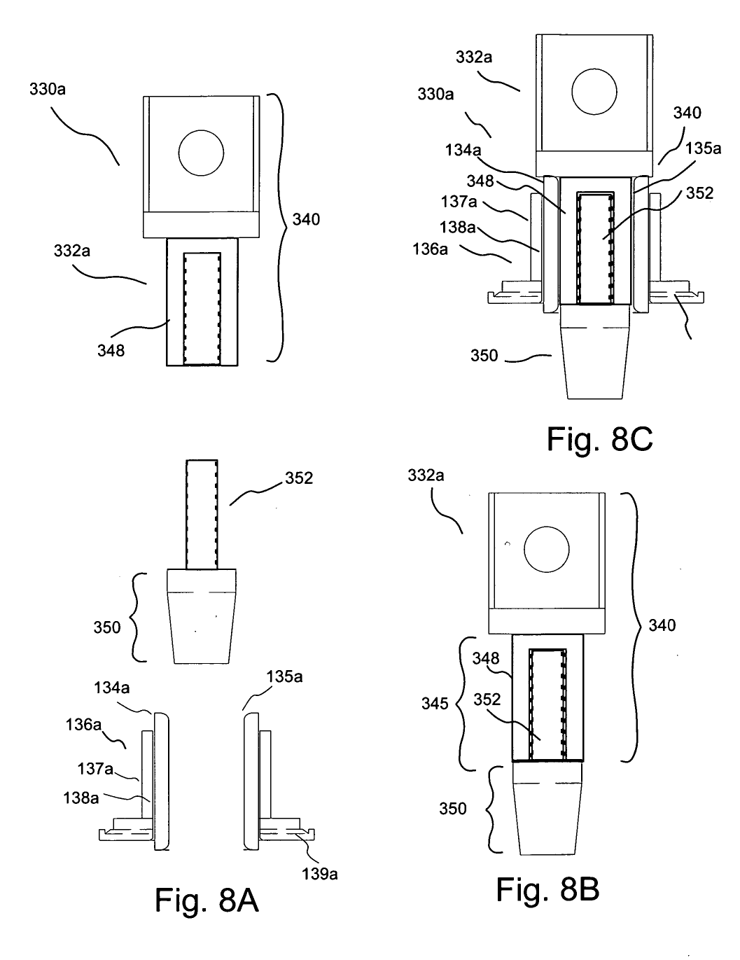

FIGS. 8A through 8C illustrate another embodiment of a terminal 330a the present invention including a terminal post 332a (for example, a positive terminal post for use in a lithium ion cell) having an electrical contact section 340 and an electrolyte contacting section 350. The electrolyte contacting section 340 is formed from a first metal suitable for contacting the electrolyte. The electrical contact section 340 is formed from a second metal that is harder than the first metal. Electrical contact section includes a connector formed on a lower end thereof (preferably monolithically therewith) such as a threaded seating or sleeve 348 that cooperates with a threaded post 352 formed (preferably monolithically) on the upper end of electrolyte contacting section 350. When connected, as illustrated in FIG. 8B, sleeve 348 and post 352 form seating section 345 wherein the harder metal of sleeve 348 enables a suitable compression seal.

As illustrated in FIG. 8C, in assembling insulated positive terminal 330a, assembled composite terminal post 332a is inserted inside passage 135a of insulating sleeve 134a and the entire assembly is subsequently crimped.

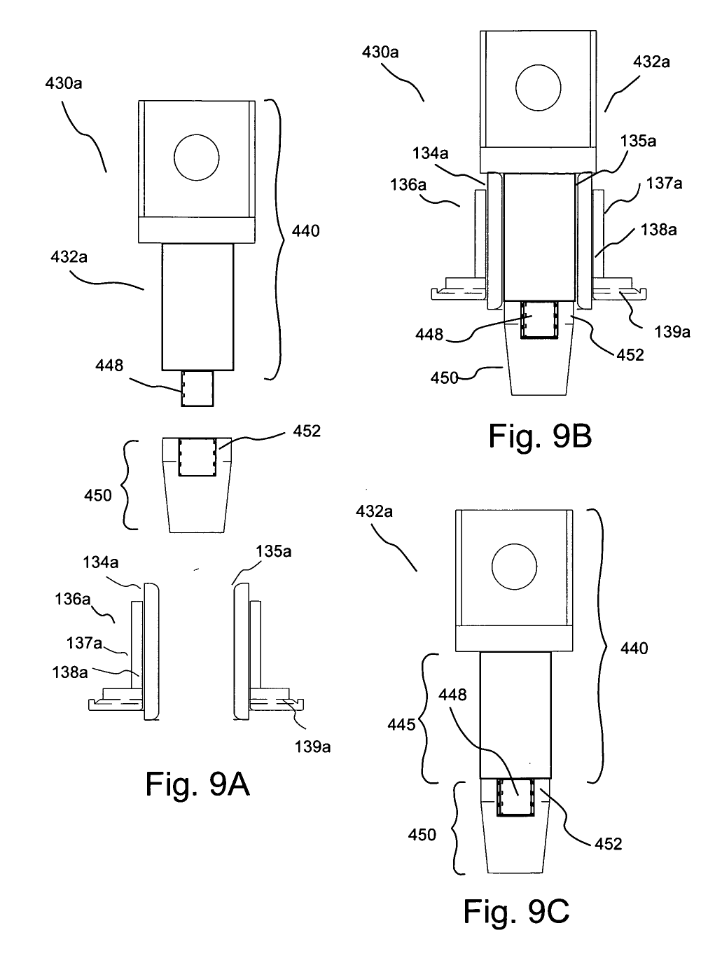

FIGS. 9A through 9C illustrate a further embodiment of a terminal 430a the present invention including a terminal post 432a having an electrical contact section 440 and an electrolyte contacting section 450. The electrolyte contacting section 440 is formed from a first metal suitable for contacting the electrolyte. The electrical contact section 440 is formed from a second metal that is harder than the first metal. Electrical contact section 440 includes a connector formed on a lower end thereof (preferably monolithically therewith) such as a threaded extending member or post 448 that cooperates with a threaded seating 452 formed (preferably monolithically) in the upper end of electrolyte contacting section 450. When connected, as illustrated in FIG. 9B, seating section 445 is formed primarily or entirely by the harder metal of electrical contact section 440, thereby enabling a suitable compression seal.

Similar to the insulated terminals described above and as illustrated in FIG. 8C, in assembling insulated positive terminal 430a, assembled composite terminal post 432a is inserted inside passage 135a of insulating sleeve 134a and the entire assembly is subsequently crimped.

Although the present invention has been described in detail in connection with the above embodiments and/or examples, it should be understood that such detail is illustrative and not restrictive, and that those skilled in the art can make variations without departing from the invention. The scope of the invention is indicated by the following claims rather than by the foregoing description. All changes and variations that come within the meaning and range of equivalency of the claims are to be embraced within their scope.

What is claimed is:

1. An insulated terminal for use in an electrochemical cell, comprising:
a terminal post; and
an insulating material forming a compression seal around the terminal post, the insulating material being formed from a polymeric material having a coefficient of thermal expansion of no greater than approximately 5.0×10⁻⁵ in./in./° F., a dielectric strength of at least 100 V/mil, a lower temperature limit no greater than −50° C., a heat deflection temperature at 264 lbs of no less than approximately 100° C., a water absorption as measured over 24 hours at 73° F. of not more than approximately 0.1%, the polymeric material being chemically resistant to an electrolyte used in the electrochemical cell and having an absorption of the electrolyte measured over 6 weeks at 71° C. of not more than approximately 0.5%.

2. The insulated terminal of claim 1 wherein the polymeric material further has a compressive strength of no less than approximately 15,000 psi with 10% strain at 73° F.

3. The insulated terminal of claim 2 wherein the polymeric material is polyphenylene sulfide, polyetheretherketone, polyetherketone, polyamide-imide or polyetherimide.

4. The insulated terminal of claim 3 wherein the polymeric material is polyphenylene sulfide.

5. The insulated terminal of claim 4 wherein the terminal post comprises copper.

6. The insulated terminal post of claim 5 wherein the terminal post comprises aluminum.

7. The insulated terminal of claim 2 wherein the terminal post comprises aluminum in that area of the terminal post that contacts the electrolyte of the electrochemical cell and comprises another metal that is harder than aluminum in that area of the terminal post contacted by the insulating material.

8. The insulated terminal of claim 7 wherein the another metal is copper.

9. The insulated terminal of claim 8 wherein the polymeric material is polyphenylene sulfide, polyetheretherketone, polyetherketone, polyamide-imide, or polyetherimide.

10. The insulated terminal of claim 9 wherein the polymeric material is polyphenylene sulfide.

11. A terminal for use in an electrochemical cell having a housing and an electrolyte within the housing, comprising: a terminal post comprising an electrolyte contacting section adapted to extend within the housing and to contact the electrolyte, the electrolyte contacting section comprising a first metal adapted to contact the electrolyte, the terminal post further comprising a contact section adapted to extend outside the housing, the contact section being in electrically conductive connection with the electrolyte contacting section, the contact section including a sealing section adapted to form a seal with an insulating material via compression, the sealing section comprising a second metal over at least a portion thereof, the second metal being harder than the first metal.

12. The terminal of claim 11 wherein the electrolyte contacting section comprises a first section adapted to extend into an interior of the housing of the electrochemical cell and a second section adapted to extend outside of the of the housing, and wherein the contact section includes a supporting section fabricated from the second metal in adjacent contact with the first metal of the second section over at least a portion of the sealing section.

13. The terminal of claim 12 wherein the second section of the electrolyte contacting section is formed to have a seating therein and the supporting section is formed as a core that is adapted to be seated within the seating of the second section.

14. The terminal of claim 13 wherein the first metal is aluminum.

15. The terminal of claim 14 wherein the second metal is copper.

16. The terminal of claim 15 further comprising a connecting mechanism for attaching the core within the seating.

17. The terminal of claim 16 wherein the connecting mechanism comprises a threaded section formed on an interior surface of the seating and a cooperating threaded section formed on an exterior surface of the core.

18. The terminal of claim 17 wherein the threaded section is coated with a first highly conductive material and the cooperating threaded section is coated with a second highly conductive material.

19. The terminal of claim 18 wherein the first highly conductive material and the second highly conductive material are nickel.

20. An electrochemical cell, comprising: a housing, an electrolyte within the housing and at least a first insulated terminal in contact with the electrolyte, the insulated terminal comprising a terminal post and an insulating material forming a compression seal around the terminal post, the insulating material being formed from a polymeric material having a coefficient of thermal expansion of no greater than approximately 5.0×10⁻⁵ in./in./° F., a dielectric strength of at least 100 V/mil, a lower temperature limit no greater than −50° C., the heat deflection temperature at 264 lbs of no less than approximately 100° C., a water absorption as measured over 24 hours at 73° F. of not more than approximately 0.1%, and an absorption of electrolyte used in the electrochemical cell as measured over 6 weeks at 71° C. of not more than approximately 0.5%, the polymeric material also being chemically resistant to the electrolyte.

21. The electrochemical cell of claim 20 wherein the polymeric material further has a compressive strength of no less than approximately 15,000 psi with 10% strain at 73° F.,

22. The electrochemical cell of claim 21 wherein the electrochemical cell is a lithium ion cell.

23. The electrochemical cell of claim 22 wherein the terminal post comprises an electrolyte contacting section extending within the housing to contact the electrolyte, the electrolyte contacting section comprising a first metal adapted to contact the electrolyte, the terminal post further comprising a contact section extending outside the housing, the contact section being in electrically conductive connection with the electrolyte contacting section, the contact section including a sealing section, the insulating material forming a compression seal around the sealing section, the sealing section comprising a second metal over at least a portion thereof, the second metal being harder than the first metal.

24. The electrochemical cell of claim 23 wherein the first metal is aluminum and the second metal is copper

25. A lithium ion electrochemical cell comprising a housing, an electrolyte within the housing and an insulated positive terminal comprising a terminal post comprising an electrolyte contacting section extending within the housing to contact the electrolyte, the electrolyte contacting section comprising aluminum, the terminal post further comprising a contact section extending outside the housing, the contact section being in electrically conductive connection with the electrolyte contacting section, the contact section comprising a sealing section, the sealing section comprising a second metal over at least a portion thereof, the second metal being harder than aluminum, the positive terminal further comprising an insulating sleeve comprising polyphenylene sulfide and a seal body comprising stainless steel, the seal body being crimped around the insulating sleeve to maintain the insulating sleeve in compressed sealing engagement with the sealing section.

26. The electrochemical cell of claim 25 wherein the second metal is copper.
